(19) United States
(12) Patent Application Publication
(10) Pub. No.: US 2026/0104068 A1
(43) Pub. Date: Apr. 16, 2026

(54) Door Module Clip Head

(71) Applicant: Illinois Tool Works Inc., Glenview, IL (US)

(72) Inventors: Hideki Kanie, Aichi (JP); Logan Scott Irvine, Chippewa Falls, WI (US)

(21) Appl. No.: 19/347,235

(22) Filed: Oct. 1, 2025

Related U.S. Application Data
(60) Provisional application No. 63/705,547, filed on Oct. 10, 2024.

(51) Int. Cl. F16B 21/08; B60J 5/04

(52) U.S. Cl. CPC F16B 21/084; B60J 5/0469; F16B 2200/50

(57) ABSTRACT

A fastener assembly includes a head section with an outer profile configured to engage a tool socket. The outer profile comprises flat portions meeting at vertex regions, at least one of which has a radius of curvature selected to define a torque threshold at which the head section slips relative to the socket. The outer profile can be hexagonal, rectangular, or triangular, and may include a slot to receive a blade-type driver. Cantilevered flat portions may also be provided to flex at a predetermined torque.

### RELATED APPLICATION

The present application claims priority to U.S. Provisional Ser. No. 63/705,547 , filed Oct. 10, 2024, and entitled “Door Module Clip Head,” which is hereby incorporated by reference in its entirety.

### BACKGROUND

Automotive components necessitate fastening techniques that prioritize simplicity in manufacturing and assembly while maintaining reliability and efficiency. Vehicle doors, like those on automobiles, transition between open and closed positions and often incorporate interior controls.

A typical vehicle door includes a main frame. In some cases, there is a door module attached to the main frame, usually secured via one or more fasteners. This assembly not only mounts the module, but also seals it to the frame to prevent moisture ingress; a process that is traditionally labor-intensive. Attaching the door module to the door structure, rather than integrating them, streamlines the manufacturing process. The structure, usually metal, defines the window contour, while the module (whether metal or plastic) fits therein. This separation eases installation of components, such as window actuators, because it is simpler for the assembler, such as an OEM (original equipment manufacturer) facility, to assemble each component separately.

Nevertheless, despite existing advancements, a need exists for systems and methods that efficiently facilitate the securing of two components, such as a door module and a door structure of, for example, a motor vehicle.

### SUMMARY

The present disclosure relates generally to systems and methods that efficiently facilitate the securing of two components. More particularly, the present disclosure relates generally to a door module clip head, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates an assembly diagrammatic view of a door structure and a door module, respectively.

FIG. 1b illustrates an assembled diagrammatic view of the door structure and the door module, respectively.

FIGS. 2a through 2d illustrate, respectively, top-side isometric assembly and assembled views of a fastening system having a fastener assembly in accordance with an aspect of this disclosure.

FIGS. 3a and 3b illustrate isometric views of a first tool for use in assembling the fastening system during an example assembly process.

FIGS. 4a and 4b illustrate isometric views of a second tool with a torque recorder for use in assembling the fastening system during an example assembly process.

FIG. 5a illustrates an isometric view of the fastener assembly in one example.

FIGS. 5b and 5c illustrate, respectively, top and bottom plan views of the fastener assembly.

FIGS. 5d and 5e illustrate, respectively, top and bottom isometric views of the fastener assembly.

FIGS. 5f through 5i illustrate, respectively, first, second, third, and fourth side elevation views of the fastener assembly.

FIGS. 5j and 5k illustrate, respectively, cross-sectional isometric and side elevation views of the fastener assembly taken along cut line A-A (FIG. 5b).

FIGS. 6a and 6b illustrate, respectively, isometric and top plan views of the fastener assembly in another example.

FIG. 6c illustrates a top plan view of the head section relative to the shape of the socket.

FIG. 7a illustrates a top plan view of the fastener assembly in yet another example.

FIG. 7b illustrates a top plan view of the head section relative to the shape of the socket.

FIGS. 8a through 8d illustrate an isometric and top plan views of the fastener assembly in yet another example.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side”and “second side”do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or. ” As an example, “x and/or y” means any element of the three-element set {(x), (y), (x, y)}. In other words, “x and/or y” means “one or both of x and y. ” As another example, “x, y, and/or z” means any element of the seven-element set {(x), (y), (z), (x, y), (x, z), (y, z), (x, y, z)}. In other words, “x, y, and/or z” means “one or more of x, y, and z.”

Prior to shipment to an assembly plant, fastener assemblies are sometimes pre-assembled with door modules at a door module supplier from the cabin-side of the door module (e.g., as a part-in-assembly). At the assembly plant, operators insert the part-in-assembly so that the fastener assembly engages with an opening in the door structure. Once clipped in place, the fastener assembly is rotated to ultimately secure the door module relative to the door structure. It is desirable to manage the torque applied during installation so as to avoid damaging the fastener portion of the fastener assembly while still ensuring proper fixation of the door module to the door structure. To address this need, the disclosed fastener assemblies provides, inter alia, features to manage the torque applied during installation.

In one example, a fastener assembly for attaching a first component having a first opening relative to a second component having a second opening comprises: a head section defining an external outer profile configured to engage a socket of a tool; and a clip body coupled to the head section and having one or more cam features configured to pass at least partially through the first opening and the second opening and to secure the first component to the second component when the clip body is rotated about an axis of rotation relative to the first component and the second component via the head section, and wherein the outer profile comprises a plurality of flat portions and a plurality of vertex regions, and wherein at least one of the plurality of vertex regions incorporates a radius of curvature associated with a torque threshold at which the head section slips axially relative to the socket.

In some examples, the outer profile is substantially hexagonal and defines six flat portions and six vertex regions.

In some examples, each vertex region includes a radius of curvature greater than zero and less than about R2.5.

In some examples, each vertex region includes a radius of curvature of between about R1.0 and about R4.0.

In some examples, each vertex region includes a radius of curvature of about R2.5.

In some examples, the outer profile is substantially rectangular and defines four flat portions and four vertex regions.

In some examples, each vertex region includes a radius of curvature of between about R1.0 and about R4.0.

In some examples, each vertex region includes a radius of curvature greater than zero and less than about R2.5.

In some examples, each vertex region includes a radius of curvature of about R2.5.

In some examples, the outer profile comprises two spaced-apart triangular portions collectively defining four flat portions and two vertex regions.

In some examples, each vertex region has a radius of curvature of between about R2.0 and about R4.5.

In some examples, each vertex region has a radius of curvature of about R2.5.

In some examples, each vertex region has a radius of curvature of about R3.0.

In some examples, each vertex region has a radius of curvature of about R4.0.

In some examples, the fastener assembly further comprises a slot formed across the head section, the slot dividing the outer profile into opposed half-portions.

In some examples, the slot is configured to receive a blade-type driver.

In some examples, the fastener assembly further comprises a seal flange, wherein one or more of the flat portions are cantilevered at a connection point relative to the seal flange, thereby defining a gap between the cantilevered flat portion and the seal flange.

In some examples, the cantilevered flat portion is elastically deflectable inward toward a central axis about the connection point when a torque threshold is reached, thereby disengaging the socket.

In some examples, a thickness of the cantilevered flat portion at or near the connection point is configured to control the torque threshold at which deflection occurs.

In some examples, the head section is integrally formed with the clip body.

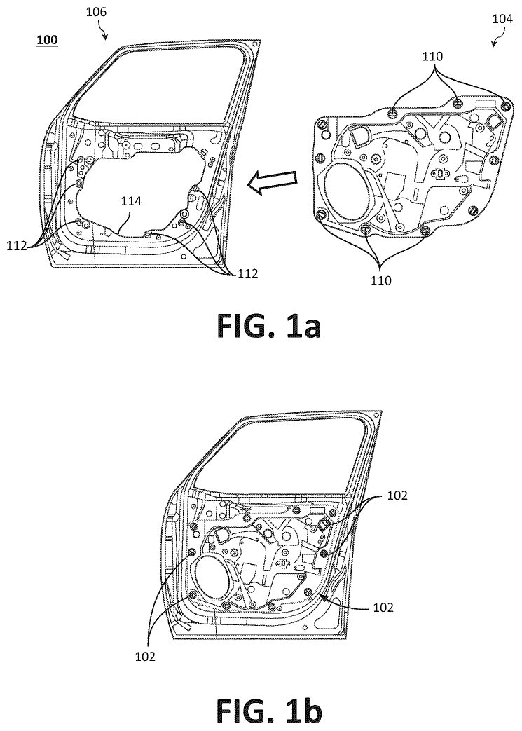

FIGS. 1a and 1b illustrate, respectively, assembly and assembled diagrammatic views of a vehicle door 100 having a first component 104 and a second component 106. Specifically, FIG. 1a illustrates an assembly diagrammatic view of a first component 104 and a second component 106, while FIG. 1b illustrates an assembled diagrammatic view of the first component 104 and the second component 106.

The first component 104 and the second component 106 may be, for example, automotive panels or other automotive components. In the illustrated example, the first component 104 is a door module and the second component 106 is a door structure that defines a cavity 114 configured to receive the door module. As illustrated, the door structure can include an upper part forming a frame designed to extend around a side window of the vehicle, and a lower part including the cavity 114. The cavity 114 is designed to be filled at least partially by the first component 104 (e.g., door module).

A plurality of fastening assemblies 202 is configured to join and secure the second component 106 relative to the first component 104. To facilitate attachment via the fastener assembly 202, each of the first component 104 and the second component 106 includes one or more engagement features, such as a first opening 110 and a second opening 112. For example, the first component 104 is illustrated as having a plurality of first openings 110 formed therein and the second component 106 is illustrated as having a plurality of second openings 112 formed therein.

Depending on the application, one or both of the first component 104 and/or the second component 106 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof.

In the illustrated example, the first component 104 and the second component 106 are joined at each of a plurality of attachment points via a fastener assembly 202 (examples of which will be discussed) that cooperates with the corresponding first opening 110 and second opening 112 to define a fastening system 102. Each of the first opening 110 and the second opening 112 is sized and shaped to receive a portion of the fastener assembly 202. The first opening 110 and the second opening 112 can be formed in the respective first component 104 or second component 106 during manufacturing thereof or added post-manufacture through a mechanical process (e.g., drilling, cutting, carving, etc.). After the first component 104 and the second component 106 are assembled, as illustrated in FIG. 1b, the first component 104 is covered at least partially by the second component 106.

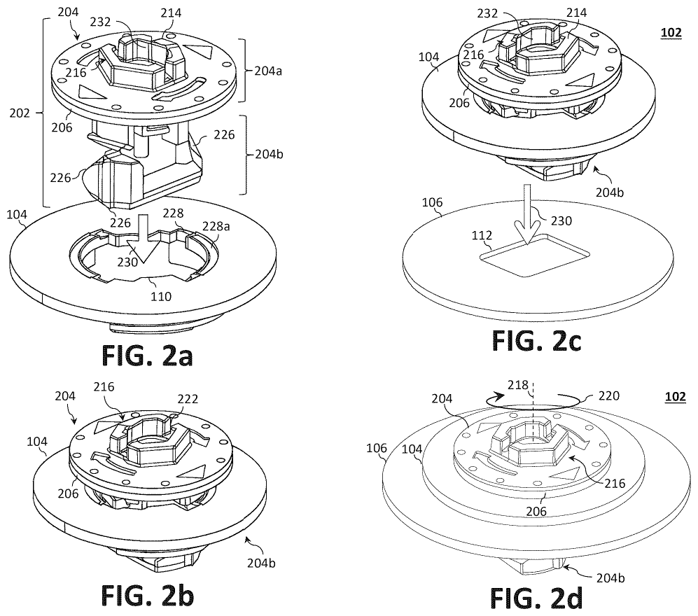

FIGS. 2a through 2d illustrate, respectively, top-side isometric assembly and assembled views of a fastening system 102 having a fastener assembly 202 in accordance with an aspect of this disclosure.

The fastener assembly 202 generally comprises a clip body 204 (e.g., a rigid structure) and an annular seal 206 (e.g., a pliable structure). The clip body 204 generally defines a first body portion 204a that defines the head section 216 and a second body portion 204b configured to engage the first component 104 and the second component 106. A seal flange 208 is positioned between the first body portion 204a and the second body portion 204b. In the illustrated example, the seal flange 208 is positioned between the first body portion 204a and the second body portion 204b. In some examples, the first body portion 204a and the second body portion 204b generally resemble posts having a cross-sectional profile that, at one or more positions along its length, is one of more of circular, quadrilateral, hexagonal, or the like.

In one example, portions of the clip body 204 (including the seal flange 208) are formed from a rigid material and as a unitary structure. The clip body 204 can be made from various materials, including synthetic or semi-synthetic polymers (e.g., plastics, such as acrylonitrile butadiene styrene (ABS) and polyvinyl chloride (PVC), etc.), composite materials (e.g., fiber glass), metal (or a metal alloy), or a combination thereof. In one example, the clip body 204 can be fabricated via mold tooling and a plastic-injection molding process. In another example, the clip body 204 can be a printed thermoplastic material component that can be printed with great accuracy and with numerous details, which is particularly advantageous, for example, in creating components requiring complex and/or precise features.

The annular seal 206 may be fabricated from a foam material, thermoplastic, rubber materials, etc. Example thermoplastics include, inter alia, polyethene (PE), polyvinyl chloride (PVC), etc. In another example, the annular seal 206 can be formed from a die cutting process and positioned on the seal flange 208 and around the first body portion 204a. By way of illustration, the annular seal 206 can be formed separately and overlaid, adhered, or otherwise positioned on the seal flange 208.

Additive manufacturing techniques obviate the need for mold tooling typically associated with plastic injection molding, thereby lowering up-front manufacturing costs, which is particularly advantageous in low-volume productions. In some examples, components of the fastener assembly 202 may be fabricated using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process. Therefore, in one example, the seal flange 208 can be a rigid plastic structure and the annular seal 206 is a softer material that is over-molded onto the seal flange 208 to form the fastener assembly 202.

The annular seal 206 assists in providing a seal between the seal flange 208 and the first component 104. The annular seal 206 limits water and/or debris from egressing through the fastener assembly 202. As illustrated, the annular seal 206 is positioned on the underside of the seal flange 208 such that it abuts a surface of the first component 104 when assembled.

The seal flange 208, which is illustrated as a generally annular plate (e.g., a disk), is configured to retain, support, and secure an annular seal 206. The seal flange 208 can include a plurality of openings 210 to increase attachment and/or surface area contact with the annular seal 206. For example, portions of the annular seal 206 can protrude, flow, or otherwise pass through and/or into the openings 210 to increase attachment with the seal flange 208.

Each of the first body portion 204a and the second body portion 204b comprises one or more features for manipulation thereof and/or for securing with the first component 104 and/or the second component 106. The first body portion 204a includes one or more manipulable features configured to be manipulated by hand or to engage a tool 212 (e.g., a socket, screw-driver, torque wrench, etc.) and one or more engagement features configured to engage the first component 104, while the second body portion 204b includes one or more engagement features configured to engage the second component 106. The tool 212 can be a hand tool or power tool (e.g., an electric or pneumatic power tool).

The illustrated first body portion 204a, for instance, includes a head section 216. The head section 216 defines an inner recess 232 and an outer profile 214. The inner recess 232 is configured to receive one type of tool 212 (e.g., an allen wrench), while the outer profile 214 can cooperate with another type of tool 212 (e.g., a socket wrench). As illustrated, each of the inner recess 232 and the outer profile 214 is hex-shaped. The illustrated head section 216 further defines a slot 222 (gap or spacing) along its center line (when viewed from the top). The slot 222 can cooperate with yet another type of tool 212 (e.g., a flat screwdriver). While the outer profile 214 and the inner recess 232 are each illustrated as hex-shaped (i.e., 6-sided), other shapes are contemplated depending on whether it is hand-manipulated and/or by the type of tool; including, for example, knobs, triangular, square, star, X-shaped, D-shaped, etc.

During assembly, the second body portion 204b of the clip body 204 is inserted into the first opening 110 of the first component 104 as indicated by arrow 230. The clip body 204 can be retained relative to the first component 104 via one or more one or more resilient latches 224. The second body portion 204b of the clip body 204 (as a part-in-assembly, for example) is then inserted into the second opening 112 as indicated by arrow 230. Once in place, the clip body 204 is rotated about the central axis 218 as indicated by arrow 220.

The operator can, for example, engage and rotate the first body portion 204a (and, thus, rotate the fastener assembly 202) about the central axis 218 as indicated by arrow 220 (e.g., via the tool 212) and relative to the first component 104 via one or more of the outer profile 214 of the head section 216, the slot 222, and/or the inner recess 232.

As the fastener assembly 202 rotates about the central axis 218, the one or more engagement features engage and secure the first component 104 and the second component 106. The illustrated second body portion 204b, for instance, includes one or more resilient latches 224. The resilient latches 224 are configured to snap and retain the first component 104 when the fastener assembly 202 is inserted into the first opening 110 (e.g., forming a part-in-assembly). The resilient latch 224 can be formed in a thickness of the second body portion 204b. The illustrated resilient latch includes a tab that comprises a first end connected to the second body portion 204b and a free second end configured to secure with the first component 104 and/or the second component 106.

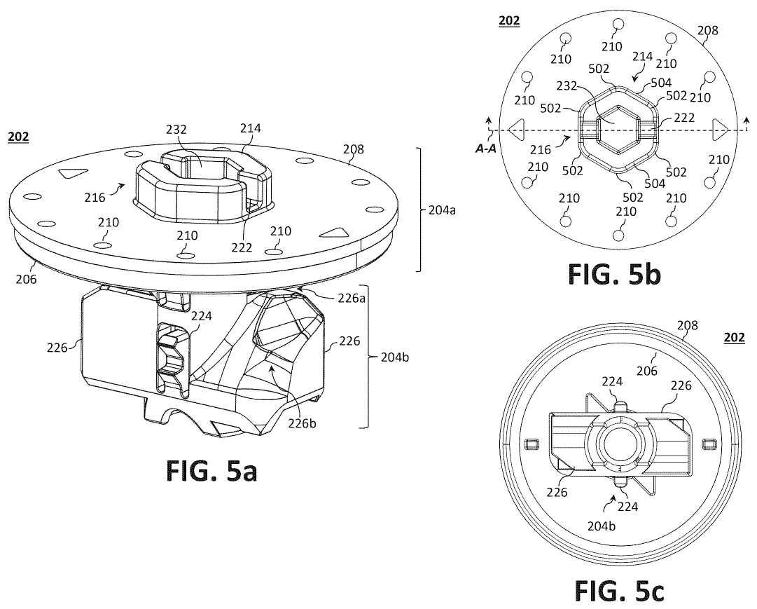

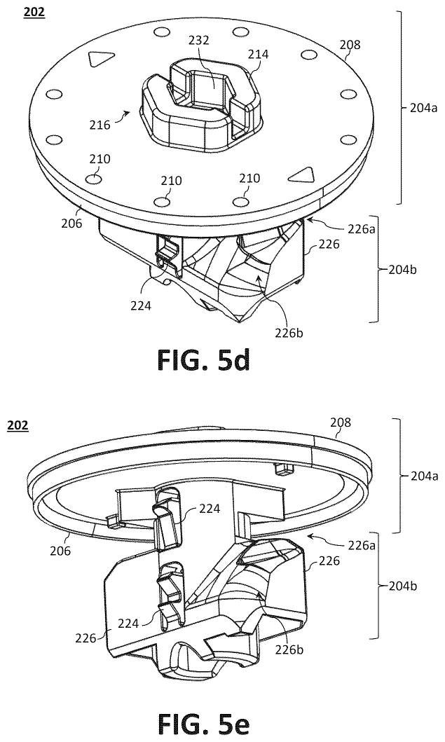

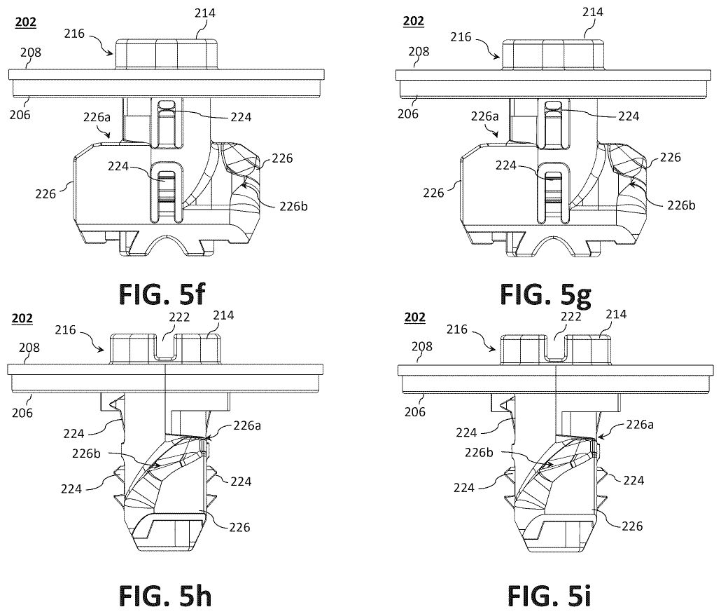

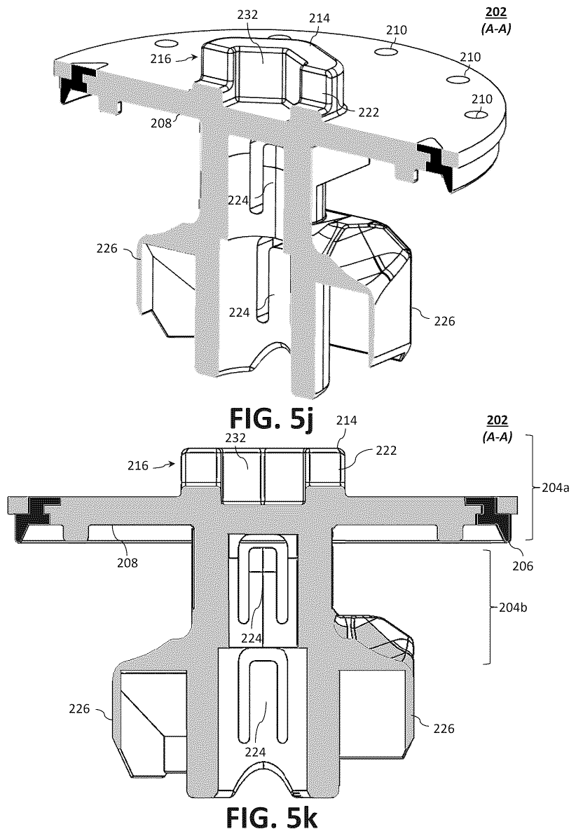

In the illustrated example, the first body portion 204a comprises four resilient latches 224 arranged such that two are at stacked (as illustrated in FIGS. 5f and 5g) and positioned on opposite sides of the central axis 218. While four are illustrated, additional or fewer resilient latches 224 may be employed depending on the number of desired attachment points with the first component 104 and the amount of turning desired to connect and disconnect the fastener assembly 202 relative to the first component 104.

The second body portion 204b of the fastener assembly 202 includes or defines two shoulders 226. In the illustrated example, the two shoulders 226 are transverse and diametrically opposite one another relative to the central axis 218. In the example shown, each shoulder 226 is shaped as a generally truncated rectangular prism. That is, each shoulder 226 is a rectangular prism having a substantially flat upper surface 226a, but cut via transverse plane to define an angled surface 226b. The angled surface 226b serves as a cam surface or ramp surface to guide the second component 106 closer to the first component 104 one another when rotated about the central axis 218. That is, the angled surface 226b is configured to cooperate with a complementary surface of the second component 106 when the fastener assembly 202 rotates. The direction of rotation of the 108 is shown by arrow 220.

In some examples, the fastener assembly 202 can be inserted into and secured relative to the first opening 110 via the fastener assemblies 108 to form a part-in-assembly with the first component 104. The part-in-assembly can then be joined with the second component 106 by rotating the fastener assembly 202 about the central axis 218 to secure with the second component 106 and with the second component 106 (via the shoulders 226).

The first opening 110 and the second opening 112 are configured to receive and engage a portion of the clip body 204. In the illustrated example, the second opening 112 is generally rectangular and the first opening 110 is generally circular. For example, the first opening 110 is generally circular and configured to receive and accommodate the cross-sectional profile of the second body portion 204b that is adjacent the seal flange. Similarly, the second opening 112 is generally rectangular to receive and accommodate the cross-sectional profile of the second body portion 204b.

The first opening 110 and the second opening 112 may each further comprise or define one or more engagement features configure to engage and secure the clip body 204. For example, the illustrated first opening 110 defines one or more notches 228, each notch 228 having a ramped portion 228a. During and post assembly, the one or more notches 228 are configured to engage one more features on the clip body 204.

In some instances, a tool 212 may apply excessive torque to the fastener assembly 202 through the head section 216, particularly when the tool 212 is powered (e.g., electrically, pneumatically, or otherwise). Excess torque can damage the fastener assembly 202 and reduce its fastening effectiveness. For example, the second body portion 204b may fracture, resulting in separation of the first and second components 104, 106. To mitigate this risk, the head section 216 can be configured to slip relative to the tool 212 once a predetermined maximum torque is reached, thereby protecting the fastener assembly 202. In certain embodiments, the head section 216 may be shaped or otherwise designed to deform, fracture, or disengage from the socket 304 of the tool 212 upon reaching the maximum torque threshold.

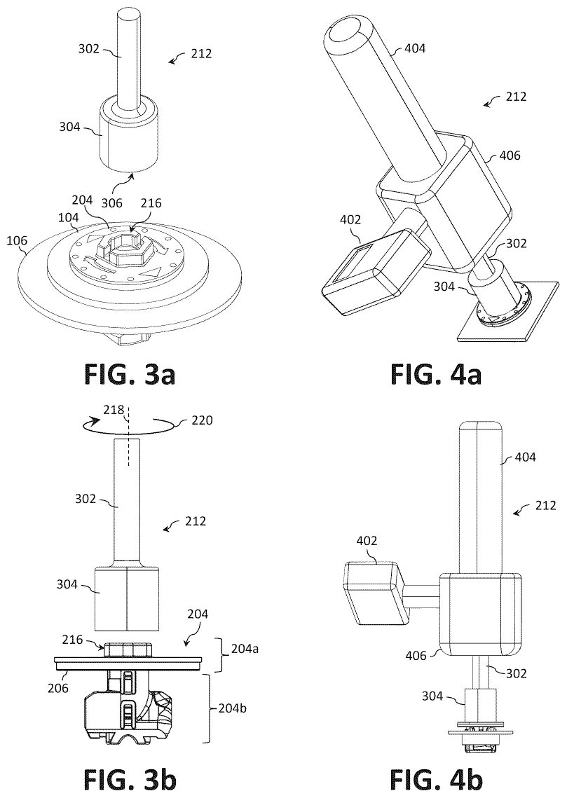

FIGS. 3a and 3b illustrate isometric views of a first tool 212 for use in assembling the fastening system 102 during an example assembly process, while FIGS. 4a and 4b illustrate isometric views of a second tool 212 with a powered driver 406 and/or a torque recorder 402 for use in assembling the fastening system 102. With reference to FIGS. 3a and 3b, the first tool 212 comprises a shank 302 with a socket 304. The socket 304 includes an opening 306 that defines a hexagonal shape 702 and is configured to receive the head section 216. The hexagonal shape 702 of the opening 306 is complementary to or compatible with the outer profile 214 of the head section 216. The shank 302 can be rotated about the central axis 218 by hand or by power. With reference to FIGS. 4a and 4b, the second tool 212 comprises a handle 404, a powered driver 406, and a torque recorder 402. The powered driver 406 is configured to rotate the shank 302 about the central axis 218, while the torque recorder 402 determines and displays the imparted torque in real time. In some examples, the powered driver 406 can be configured to shut off once a torque threshold is reached.

To obviate the need for more complex torque monitoring and/or control devices, the outer profile 214 of the head section 216 can alternatively or additionally be configured to slip relative to the socket 304 of the tool 212 once a predetermined maximum torque is reached (e.g., a torque threshold). This can be achieved by the outer profile 214 deforming, fracturing, or simply disengaging from the socket 304 of the tool 212, thereby protecting the remaining portions of the fastener assembly 202.

FIG. 5a illustrates an isometric view of the fastener assembly 202. FIGS. 5b and 5c illustrate, respectively, top and bottom plan views of the fastener assembly 202. FIGS. 5d and 5e illustrate, respectively, top and bottom isometric views. FIGS. 5f through 5i illustrate, respectively, first, second, third, and fourth side elevation views. FIGS. 5j and 5k illustrate, respectively, cross-sectional isometric and side elevation views of the fastener assembly 202 taken along cut line A-A of FIG. 5b.

As best shown in FIG. 5b, the head section 216 defines an outer profile 214 that is substantially hexagonal and configured for wrenching engagement with a complementary socket 304 of a tool 212. A slot 222 is formed across the surface of the head section 216 (e.g., coinciding with cut line A-A), thereby dividing the external hexagonal profile 214 into two opposed half-portions. Each half-portion comprises a plurality of flat portions 504 that meet at vertex regions 502. In the illustrated embodiment, the outer profile 214 defines six flat portions 504 and six corresponding vertex regions 502. However, additional or fewer flat portions 504 and vertex regions 502 may be employed depending upon the geometry of the complementary socket 304 and/or the desired torque transmission characteristics.

In certain examples, the vertex regions 502 are not sharp corners but instead incorporate a finite radius of curvature. Providing a radius of curvature at the vertex regions facilitates controlled slippage of the socket 304 once a predetermined torque is met, thereby mitigating the likelihood of overstressing or damaging the fastener assembly 202. In addition, curved vertex regions 502 reduce localized stress concentrations, which decreases the risk of crack initiation and propagation during torque application. The radius of curvature of each vertex region 502 may be selected to establish a desired torque threshold. In some examples, the radius of curvature of each of the six vertex regions 502 is greater than zero, between approximately R0.2 and approximately R5.0, between about approximately R1.0 and approximately R4.0, between about approximately R2.0 and approximately R3.0, or approximately R2.5.

For example, testing has shown that where the radius of curvature of each of the six vertex regions 502 is R0.2, the torque threshold is approximately 4.9 newton-meters (Nm). Conversely, increasing the radius of curvature of each vertex region 502 to R2.5 has been shown to reduce the torque threshold to approximately 3.0 Nm. Accordingly, increasing the radius of curvature decreases the torque threshold, while reducing the radius increases the torque threshold. The ability to tune torque response through geometric adjustment of the vertex regions 502 allows for precise control and protection of the fastener assembly 202 during installation.

The slot 222 is dimensioned to receive a blade-type driver (e.g., a flat screwdriver), thereby permitting manual rotation of the fastener assembly 202 using a conventional hand tool. At the same time, the external hexagonal profile 214 remains compatible with a socket or wrench, enabling higher torque application where needed. This combination of internal slot and external hex profile thus defines a combination-drive head geometry that provides installation flexibility, torque management, and enhanced durability of the fastener assembly 202.

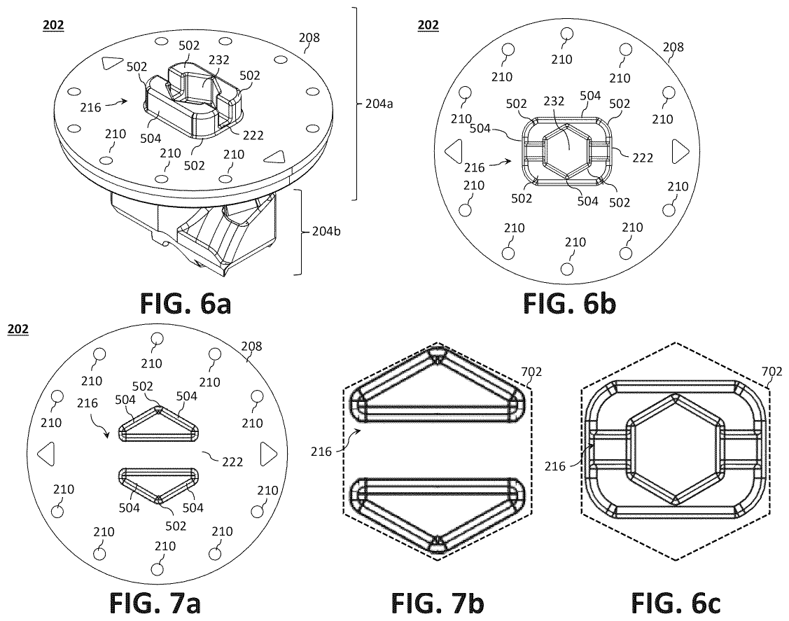

FIGS. 6a and 6b illustrate, respectively, isometric and top plan views of the fastener assembly 202 in another example. FIG. 6c illustrates a top plan view of the head section 216 relative to the hexagonal shape 702 of the socket 304. The fastener assembly 202 of FIGS. 6a and 6b is substantially identical to that of FIGS. 5a through 5k except for the head section 216.

As best shown in FIG. 6b, the head section 216 defines an outer profile 214 that is substantially rectangular and configured for wrenching engagement with a complementary socket 304 of a tool 212. While the outer profile 214 is rectangular, it remains suitable for use with a hexagonal socket 304, as represented in FIG. 6c.

A slot 222 is again formed across the head section 216, thereby dividing the external rectangular profile into two opposed half-portions. Each half-portion comprises a plurality of flat portions 504 that meet at vertex regions 502. In the illustrated embodiment, the outer profile 214 defines four flat portions 504 and four corresponding vertex regions 502.

As with the prior example, the vertex regions 502 need not be sharp corners but instead may incorporate a finite radius of curvature. The radius of curvature of each vertex region 502 may be selected to establish a desired torque threshold. In some examples, the radius of curvature of each of the four vertex regions 502 is greater than zero, between approximately R0.2 and approximately R5.0, between about approximately R1.0 and approximately R4.0, between about approximately R2.0 and approximately R3.0, or approximately R2.5. For example, testing has shown that where the radius of curvature of each of the four vertex regions 502 is R2.5, the torque threshold is approximately 2.0 newton-meters (Nm). Increasing the radius of curvature decreases the torque threshold, while reducing the radius increases the torque threshold.

FIG. 7a illustrates a top plan view of the fastener assembly 202 in yet another example. FIG. 7b illustrates a top plan view of the head section 216 relative to the hexagonal shape 702 of the socket 304. The fastener assembly 202 of FIGS. 7a and 7b is substantially identical to that of FIGS. 5a through 5k except for the head section 216.

The head section 216 defines an outer profile 214 composed of two spaced-apart triangles configured for use with a hexagonal socket 304 of a tool 212. Each of the two spaced-apart triangles comprises a plurality of flat portions 504 that meet at one or more vertex regions 502. In the illustrated embodiment, the outer profile 214 defines four flat portions 504 and two vertex regions 502.

As with the prior examples, the vertex regions 502 need not be sharp corners but instead may incorporate a finite radius of curvature. The radius of curvature of each vertex region 502 may be selected to establish a desired torque threshold. In some examples, the radius of curvature of each of the two vertex regions 502 is greater than zero, between approximately R0.2 and approximately R5.0, between about approximately R1.0 and approximately R4.0, between about approximately R2.0 and approximately R4.5, or approximately R2.5, R3.0, or R4.

For example, testing has shown that where the radius of curvature of each of the two vertex regions 502 is R2.5, the torque threshold is approximately 1.39 newton-meters (Nm). Increasing the radius of curvature decreases the torque threshold, while reducing the radius increases the torque threshold. For instance, where the radius of curvature of each of the two vertex regions 502 is R3, the torque threshold is approximately 0.6 Nm, and where the radius is R4, the torque threshold is approximately 0.4 Nm.

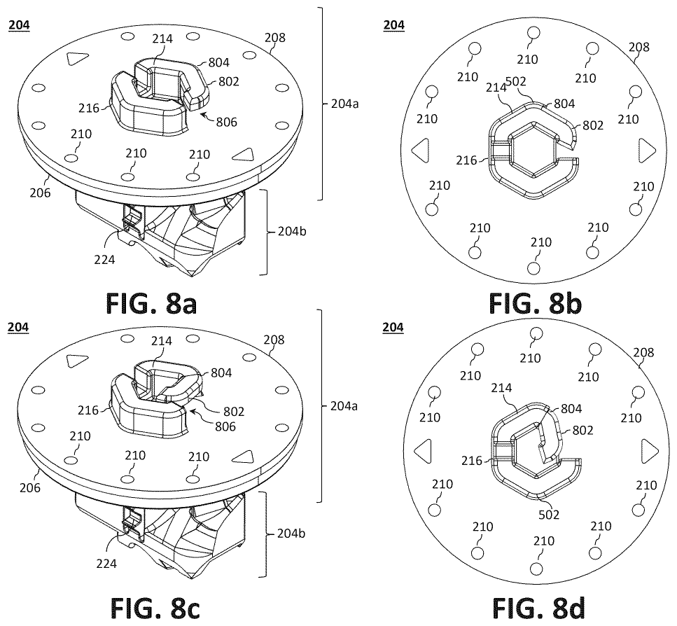

FIGS. 8a through 8d illustrate, respectively, isometric and top plan views of the fastener assembly 202 in yet another example. In this embodiment, one or more of the plurality of flat portions 504 are cantilevered at a connection point 804 relative to the seal flange 208 such that a gap 806 is defined between the cantilevered flat portion 802 and the seal flange 208.

As with the prior examples, the vertex regions 502 need not be sharp corners but instead may incorporate a finite radius of curvature. In some examples, the radius of curvature of each of the two vertex regions 502 is greater than zero, between approximately R0.2 and approximately R5.0, between about approximately R1.0 and approximately R4.0, between about approximately R2.0 and approximately R3.0, or approximately R2.5.

FIGS. 8a and 8b illustrate, respectively, top isometric and top plan views of the fastener assembly 202 with the cantilevered flat portion 802 in a default state, while FIGS. 8c and 8d illustrate, respectively, top isometric and top plan views of the fastener assembly 202 with the cantilevered flat portion 802 in a deflected state. When a torque threshold is reached, the cantilevered flat portion 802 elastically deflects inward toward the central axis 218 about the connection point 804. This inward deflection causes the socket 304 of the tool 212 to disengage or slip, thereby preventing the application of torque beyond the desired limit. The number of cantilevered flat portions 504 may be selected to adjust the overall torque response of the head section 216. In addition, the geometry of each cantilevered flat portion 802—such as its thickness, length, and width at or near the connection point 804—may be varied to increase or decrease the torque threshold at which inward deflection occurs.

While the various examples illustrate a slot 222 and an inner recess 232, the slot 222 and inner recess 232 can be omitted, where the outer profile 214 would serve as the primary or even sole engagement feature.

While the present method and/or system have been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A fastener assembly for attaching a first component having a first opening relative to a second component having a second opening, the fastener assembly comprising:
a head section defining an external outer profile configured to engage a socket of a tool; and
a clip body coupled to the head section and having one or more cam features configured to pass at least partially through the first opening and the second opening and to secure the first component to the second component when the clip body is rotated about an axis of rotation relative to the first component and the second component via the head section, and
wherein the outer profile comprises a plurality of flat portions and a plurality of vertex regions, and
wherein at least one of the plurality of vertex regions incorporates a radius of curvature associated with a torque threshold at which the head section slips axially relative to the socket.

2. The fastener assembly of claim 1, wherein the outer profile is substantially hexagonal and defines six flat portions and six vertex regions.

3. The fastener assembly of claim 2, wherein each vertex region includes a radius of curvature greater than zero and less than about R2.5.

4. The fastener assembly of claim 2, wherein each vertex region includes a radius of curvature of between about R1.0 and about R4.0.

5. The fastener assembly of claim 2, wherein each vertex region includes a radius of curvature of about R2.5.

6. The fastener assembly of claim 1, wherein the outer profile is substantially rectangular and defines four flat portions and four vertex regions.

7. The fastener assembly of claim 6, wherein each vertex region includes a radius of curvature of between about R1.0 and about R4.0.

8. The fastener assembly of claim 6, wherein each vertex region includes a radius of curvature greater than zero and less than about R2.5.

9. The fastener assembly of claim 6, wherein each vertex region includes a radius of curvature of about R2.5.

10. The fastener assembly of claim 1, wherein the outer profile comprises two spaced-apart triangular portions collectively defining four flat portions and two vertex regions.

11. The fastener assembly of claim 10, wherein each vertex region has a radius of curvature of between about R2.0 and about R4.5.

12. The fastener assembly of claim 10, wherein each vertex region has a radius of curvature of about R2.5.

13. The fastener assembly of claim 10, wherein each vertex region has a radius of curvature of about R3.0.

14. The fastener assembly of claim 10, wherein each vertex region has a radius of curvature of about R4.0.

15. The fastener assembly of claim 1, further comprising a slot formed across the head section, the slot dividing the outer profile into opposed half-portions.

16. The fastener assembly of claim 15, wherein the slot is configured to receive a blade-type driver.

17. The fastener assembly of claim 1, further comprising a seal flange, wherein one or more of the flat portions are cantilevered at a connection point relative to the seal flange, thereby defining a gap between the cantilevered flat portion and the seal flange.

18. The fastener assembly of claim 17, wherein the cantilevered flat portion is elastically deflectable inward toward a central axis about the connection point when a torque threshold is reached, thereby disengaging the socket.

19. The fastener assembly of claim 17, wherein a thickness of the cantilevered flat portion at or near the connection point is configured to control the torque threshold at which deflection occurs.

20. The fastener assembly of claim 1, wherein the head section is integrally formed with the clip body.
